(19) United States
(12) Patent Application Publication
(10) Pub. No.: US 2004/0139176 A1
(43) Pub. Date: Jul. 15, 2004

(54) Systems and methods for improving service delivery

(76) Inventors: Kevin Farrell, Windham, NH (US); Steven D. Domenikos, Millis, MA (US); George C. Domenikos, Saugus, MA (US); Sasha Epstein, Reading, MA (US)

Correspondence Address: ROPES & GRAY LLP, ONE INTERNATIONAL PLACE, BOSTON, MA, 02110-2624, US

(21) Appl. No.: 10/651,758

(22) Filed: Aug. 29, 2003

Related U.S. Application Data
(60) Provisional application No. 60/407,193, filed on Aug. 29, 2002.
(60) Provisional application No. 60/434,001, filed on Dec. 16, 2002.

(51) Int. Cl. G06F 15/177

(52) U.S. Cl. 709/220

(57) ABSTRACT

Methods for deploying improved telecommunication services. The methods comprise the steps of providing one or more existing service packages, each being a set of instruction for deploying a telecommunications service. In a further step the method provides a platform runtime environment that has a work flow engine and a pipeline engine that is capable of interpreting the service package to carry out the instructions therein. In an additional step, the method provides a user interface for configuring the one or more service packages. The user interface is configured to receive user input by offering a plurality of functional elements that may be manipulated by a user to describe one or more operations of the service packages, each functional element having one or more properties that may be controlled by the user. In a further step the method configures one or more features of the service package in response to the user input to alter the telecommunications service.

### REFERENCE TO RELATED APPLICATIONS

This Application claims priority to U.S. patent application 60/407,193 filed 29 Aug. 2002 entitled Service FullFillment Engine and Interfaces, and U.S. patent application 60/434,001 entitled Service Delivery Assurance, filed 16 Dec. 2002; both naming George Domenikos, Steven Domenikos and Sasha Epstein as inventors, the contents of both Applications being incorporated by reference herein.

### BACKGROUND

Today, the telecommunications industry is evolving and expanding at unprecedented speed. New technologies are being developed and introduced each day. These new technologies create an opportunity to develop services of value to customers. However, the pace at which these technologies are being introduced and the demands that customers place on service providers today, means that service providers must be able to execute flawlessly on the introduction and delivery of these new technologies.

Increasingly, different types of services are likely to be offered over communications different types of networks. For instance the increasing capability of technology is enabling a future where a wide variety of multimedia services can be delivered to users over communications networks. These services could include simple voice telephony, multimedia conference amongst many users, home shopping and video on demand. Additionally users may want such services to be delivered over a variety of network and terminal types such as a portable phone, portable personal computer and domestic cable television set with a set-top-box.

In the light of this accelerating complexity in the world of communications, with many different entities being involved in the exploitation of a fast growing range of different services, there is a clear need for sophisticated service provision and/or management systems. To this end, there is a demand for systems that can help network operators and service providers streamline operations, including delivery operations, increase network flexibility, and reduce operating and capital expenditures.

Moreover, the current paradigm and approach to enabling service delivery is focused on integration value, design tools and best practices. Huge amounts of time and money are often invested in projects that glue together applications around a process with no clear or tangible return on that investment. Projects are bid, built, transferred to the customer, and billed—end of story. Consistently network owners say that they know that they have spent money, time and resources trying to improve their process, but they do not know whether it was worth the investment, and that their business is proportionately better off.

What is missing under the current paradigm is the bridge between the investment and the return. Moreover, there is a need to offer customers a near risk-free method of investing into their business. Solutions that may be good investments can be offered to customers; but what is challenging is getting the customer to trust and implement the solution. In large part, this is because these customers have had bad experiences by the current (and past) paradigm, which required a leap-of-faith commitment to a solution, with no visibility or guarantee around the results.

Accordingly, there is a need for systems and methods that reduce the risk to the customer of implementing a new solution and demonstrate the results of their investment. There is a further need for systems that incrementally target the next and optimal return on future investments, allowing customers to leverage money, time and resources to improve process.

### SUMMARY OF THE INVENTION

The systems and methods described herein include, among other things, methods for deploying improved telecommunication services. The methods comprise, certain embodiments and practices, the steps of providing one or more existing service packages, each being a set of instruction for deploying a telecommunications service. In a further step the method provides a platform runtime environment that has a work flow engine and a pipeline engine that is capable of interpreting the service package to carry out the instructions therein. In an additional step, the method provides a user interface for configuring the one or more service packages. The user interface is configured to receive user input by offering a plurality of functional elements that may be manipulated by a user to describe one or more operations of the service packages, each functional element having one or more properties that may be controlled by the user. In a further step the method configures one or more features of the service package in response to the user input to alter the telecommunications service.

In a further aspect, the invention will be understood to provide systems that support the development and deployment of services, such as telecommunication services, over a network. In one embodiment, the systems include at least one service package that has a set of instructions for carrying out and/or deploying a telecommunications service. The system also includes a runtime environment, or process, that is capable of processing instructions stored in the one or more service packages for the purpose of carrying out the service or deployment. The system further includes one or more adapters, each of which is capable of interfacing the system to the external network environment through which the communication service will be deployed. Optionally and preferably the system may also include an integrated development environment for allowing a user to develop a service package which can be executed within the runtime environment but directing the external network, through the adapters, to implement the user developed service.

The service package concept allows the technology to be applied to a wide spectrum of service types. The encapsulated domain knowledge included into the service package, the modularity and ease of enhancement of the service package, coupled with the runtime service delivery dash board analytics views, provides for the distinct characteristics of the invention.

The systems and methods described herein, in a further aspect, include service delivery assurance systems and methods that allow a client or customer to develop a service package that can implement and process a particular service for the customer, and allows the customer to build into the service package, as it is being developed, functionality that will later report on the effectiveness of that service package when it is being employed. Accordingly, the invention provides, among other things, systems that monitor and audit a service package as it is being executed.

As will be described herein, a service package is a service or collection of services that can be ordered and delivered through an automated order fulfillment process that coordinates and integrates a plurality of service components and resources that are necessary, or relevant, to the deployment of the service at hand. For example, in one embodiment, the systems and methods provide for telecommunication services to be developed and monitored for effectiveness. Such telecommunication services can include, for example, a cable internet access service. The service provider in this case may be a cable company offering internet access through its cable network. A customer ordering this service from the cable company would need to have the order filled by the cable company, which in turn, would require the cable company to provision the necessary resources, such as a cable modem, an IP address, an account on the system for billing purposes, and a service man for installing the cable modem at the customer's home. As described herein, the systems provide the tool that is capable of allowing a customer, in this case, the cable network operator, to bring together, organize and coordinate the different activities necessary to fulfill the customer's order of cable network access. In this way, the customer can develop order fulfillment processes that are more efficient and reduce the likelihood that the company will fail to fill the order of a customer or will do so incorrectly.

From time to time, it may be in the interest of the cable company to adjust the way this cable modem service is provided to customers. In theses case, the systems described herein will allow the cable operator to modify the service package the provides that cable modem service. As described herein, the systems and methods of the invention also allow the cable network operator to build into the modified service package functionality that can audit and monitor the efficiency of the modified service package so that the cable network operator can collect information about the efficiency and ethicacy of the modified service and compare the operation of the modified service against the operation of the earlier service. In this way, the cable network operator can determine whether the modified service is more effective than the earlier service. Additionally, as described herein, the cable network operator can add into the service package functionality that is capable of monitoring the operation of certain aspects of the service package which may be subject to failure or poor performance. In this way, the cable network operator can employ the service delivery assurance systems described herein to identify trouble spots within the service delivery process.

### BRIEF DESCRIPTION OF THE FIGURES

The systems and methods described herein will be understood more completely with reference to the following figures and diagrams in which like reference numbers refer to like elements;

FIG. 1 illustrates a first embodiment of a system according to the invention;

FIG. 2 depicts an embodiment of the invention showing a plurality of service packages installed within this system;

FIG. 3 depicts graphically user interfaces for developing a service package suitable for use with the system depicted in FIG. 2;

FIG. 4 illustrates in greater detail the client for generating a service package;

FIG. 5 depicts one example of a process for graphically modeling an abstract data model;

FIG. 6 depicts a process for graphically cresting an adapter;

FIG. 7 illustrates a process for modeling the process for deploying a service;

FIG. 8 depicts a synchronous adapter for communicating with external systems;

FIG. 9 depicts an a synchronous adapter for communicating with external systems;

FIG. 10A-10C depict a process definition in graphical form and as a source file;

FIG. 11 depicts a model of a service package and the runtime model systems described herein;

FIG. 12 depicts a flowchart of a process for executing a service package in the runtime module;

FIG. 13 depicts a diagram of a service analytics process; and

FIG. 14 depicts a user interface illustrating collected service analytics.

### DESCRIPTION OF THE ILLUSTRATED EMBODIMENTS

To provide an overall understanding of the systems and methods described herein, certain illustrative embodiments will now be described, including a system that allows for developing improved services and service delivery.

The systems and methods described herein include the systems for developing and deploying services, such as telecommunication services, and for improving services and service delivery by allowing a user to amend and update a developed service and for measuring characteristics of a service or versions of a service to select among different services and versions to achieve a selected improvement.

To this end, the systems described herein are capable of fielding requests to deploy a service from multiple different sources and are capable of driving and directing the operation of external systems for the purpose of deploying the requested service. The systems include an order handling module that has set of interfaces that can receive orders for a service from different sources. For example, the system can receive through a self-service web interface, a request to provide a customer with VoIP service within the customer's company and externally as well. Once the order is received the system can begin the process of deploying that service. To deploy the requested service, the system calls upon a service package that was identified by the order, and runs the service package in a runtime environment. The service package is a definition of the requested service or set of related services and allows for service creation by encapsulating the definitions, configurations, parameters, and actions that comprise the actions needed to deploy the communications service. As will be discussed in more detail below, the service package includes an abstract data model that captures the data needed to deploy the requested service, such as information for setting up a new customer account and information for provisioning resources, such as modems. The service package also includes process definitions that implement the business rules that govern the service and orchestrate the fulfillment of services. The service package also includes adapters that map received data from a device specific format into an XML instance of a corresponding data model, and map data from a corresponding Data Model into a format specific to a particular external device. For example, the service package includes the logic and an abstract data model of the information required to deploy to a customer a VoIP service that runs on an internal network and connects to the PSTN. The runtime environment processes information stored in a service package to drive the external systems that need to be activated to deliver the requested service.

By abstracting the service deployment process into a service package, the systems and methods described herein are able to execute a generic process within the runtime environment, and push the platform specific processing tasks to the edge of the system. This provides for easier integration of new network components. Moreover, in certain optional embodiments, the developers can be provided with a library of service packages that provide templates that can be modified as necessary to integrate with the customer's external systems. This provides a rapid development and employment environment for delivering services and fulfilling orders.

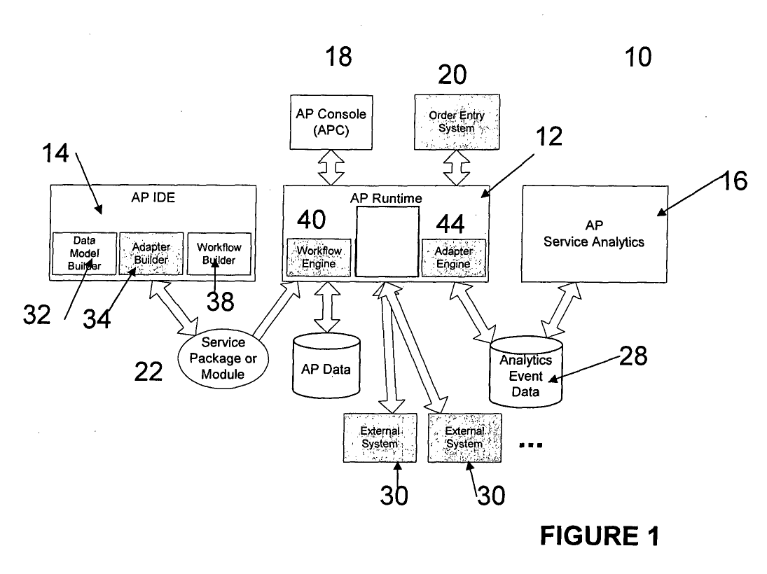

FIG. 1 depicts a first embodiment of a system according to the invention. Specifically, FIG. 1 depicts a system 10 that includes a runtime module 12, and integrated development environment (IDE) 14, and a service analytics process 16. As further shown in FIG. 1, the runtime environment 12 communicates with a console 18 and an order entry system 20. Additionally, the runtime environment 12 stores data within the database 24 and exchanges information with the external systems 30. An analytics event database 28 couples between the runtime environment 12 and the service analytics process 16. A service package and/or module 22 is coupled to the IDE 14 and the runtime environment 12.

The depicted system 10 is a software tool that may act as middleware that sits between a system operator and one or more external network systems 30. As will be described in more detail hereinafter the system 10 provides the operator with a platform that the operator may use for developing and improving services and processes and for deploying services across the external network(s) 30. To this end, the system 10 includes the IDE 14 that allows the operator to develop services that can be executed by the runtime module 12. The runtime module process 12 provides a layer of abstraction for allowing services created using the IDE 14 to be executed on the user's network system 30. As the network system may comprise a host of components from different manufacturers, the runtime module 12 provides for brokering communication between the services developed by the operator and the different elements of the external network 30. Additionally, the system 10 shown in FIG. 1 also provides for a service analytics process 16 that can collect information about the operation of different services as well as the success of service deployment. The information collected by the service analytics process 16 may be stored in the database 28 and subsequently used for identifying services that are performing better or that are being deployed more easily than other services or versions of services. In this way, the system 10 allows users to develop services, deploy them and to monitor them.

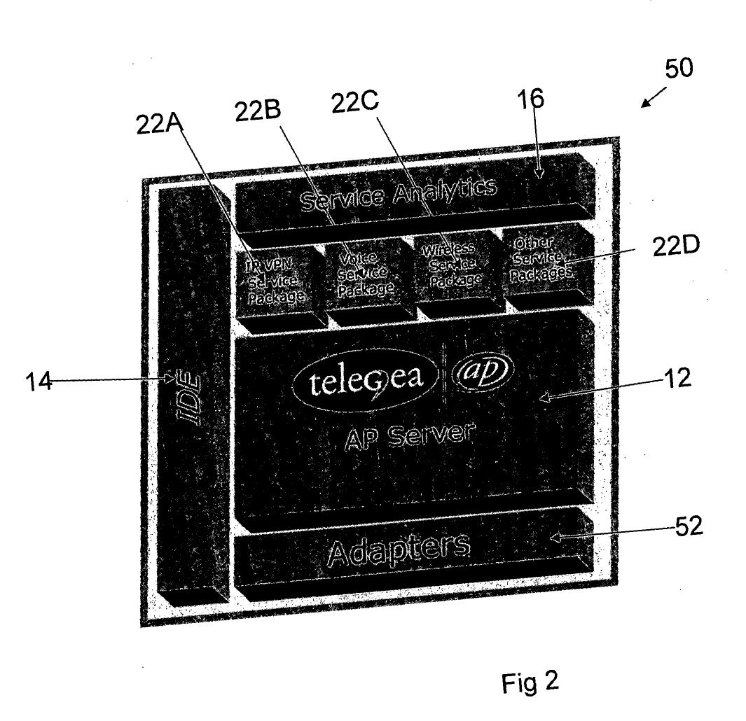

Turning to FIG. 2, one system 50 according to the invention is depicted for the purpose of showing that the system may include a plurality of installed service packages 22 each of which is capable of providing a service that may be deployed on the external network 30. Accordingly, the systems described herein are programmable platforms that can act as middleware between the operator and the external network or networks 30. Each of the service packages 22a through 22d can be installed on the system and, when an order comes in from the order entry system 20 requesting service to be deployed, the appropriate service package 22a through 22d may be activated and run on the runtime module 12. In the depicted embodiment the service packages 22 include a service package 22a that provides for an IP VPN service, a service package 22b provides a voice service, a service package 22c provides a wireless service package and a service package 22d that is meant to represent that other types of service packages may also be provided. For example, service packages can be provided for VoIP services, videoconferencing services, quality of service services, revenue assurance services, prepaid services and security services. However, it will be apparent to those skilled in the art that these services are merely representative of the kinds of services that can be carried out in the system 50 and other services may be developed all of which will fall within the scope of the invention.

Although the systems and methods described herein may be employed for developing, and delivering any type of service, such as a financial service, or a medical service, the systems and methods described herein are, for the purpose of clarity, being described with reference to telecommunication services. Such telecommunication services can include IP virtual private networks (VPN) as well as wireless services, and other types of services. Thus, the illustrated systems facilitate the development and deployment of telecommunication services. However, it will be apparent to those of skill in the art that the systems and methods described herein are not so limited and may be employed in other applications, with modifications, additions, and substitutions, being made as required by the application.

The depicted system 10 fulfills orders for services and allows customers (Service Providers, Systems Integrators, services organization, etc.) to define the service and process for fulfilling orders for that service. For this embodiment, a service or collection of services is termed a service package 22. The service package 22 can be deployed to the runtime module 12 where it is used to fulfill orders. The system 10 also that provides operators with real-time and historical views into the service delivery process, providing them with insights into that process, and allowing them to know more about their business. The results of the incremental investments in the process may be viewable with before and after views. In addition, the system 10 optionally can highlight trouble spots, providing guidance for further improvement. Once identified, a service can be extended to further improve the process, re-deployed, and again measured for the results.

IDE Module

More particularly, FIG. 1 depicts as a functional block diagram an Integrated Development Environment (IDE) 14. Inside the IDE 14 is a data model builder 32, an adapter builder 34, and a process or workflow builder 38. The runtime module 12 can include a work flow engine 40, and an adapter engine 44. As shown in FIG. 1, the IDE may be employed to develop a service package 22. Once the service package 22 is developed, the runtime module 12 may employ that service package 22 through the workflow engine 40 to implement and fulfill an order received through the depicted order entry system 20. An adapter engine 44 may collect information about the operation of the service package 22 at runtime. This information may be stored in the depicted database 28. At a later point, the service analytics module 16 may be activated to analyze the data collected during runtime.

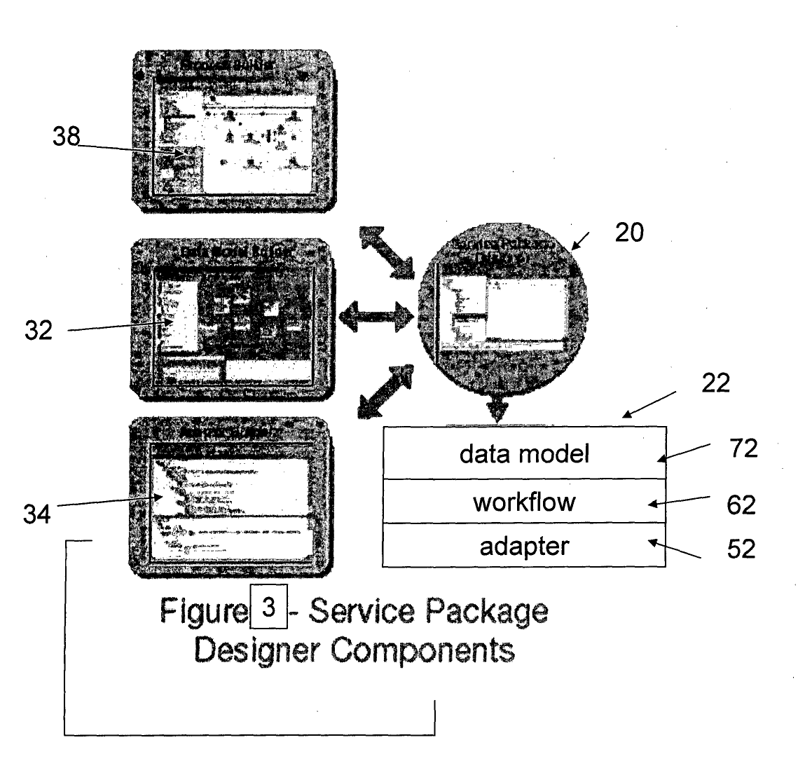

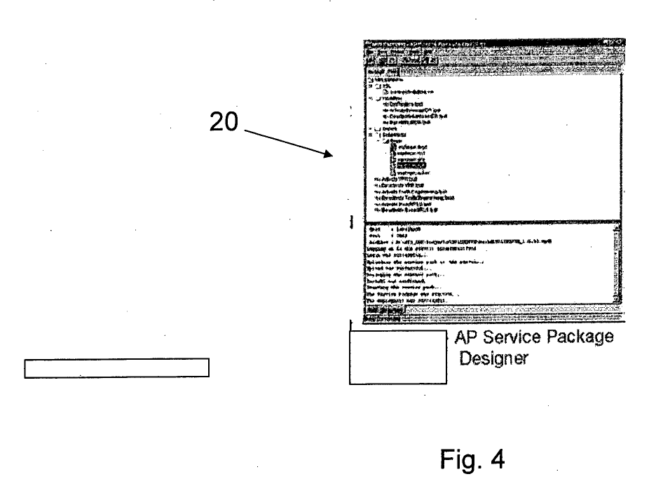

FIG. 3 depicts pictorially the systems and the process provided by the IDE 14 to create a service package 22. As will be discussed in more detail below, the service package 22 include three main components: a data model 72, a process or workflow definition 62 and one or more adapters 52. These three components provide a complete of the process for deploying the service the service associated with service package 22. To create these components, the IDE14 includes a data model builder 32, an adapter builder 34 and a process builder 38. To control the overall service package development process, the IDS 14 also includes a package designer application 20.

In one embodiment the service package 22 is a set of related XML source files that contain the information in the data model, process flow and the adapter. In this embodiment, the designer application 20 program creates and organizes the different XML source files being generated as the service package 22. The development of such file control programs follow from principles and practices well known to those of skill in the art.

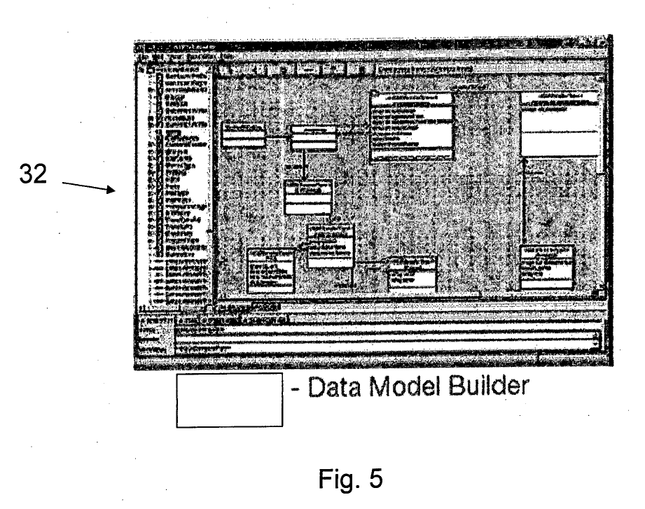

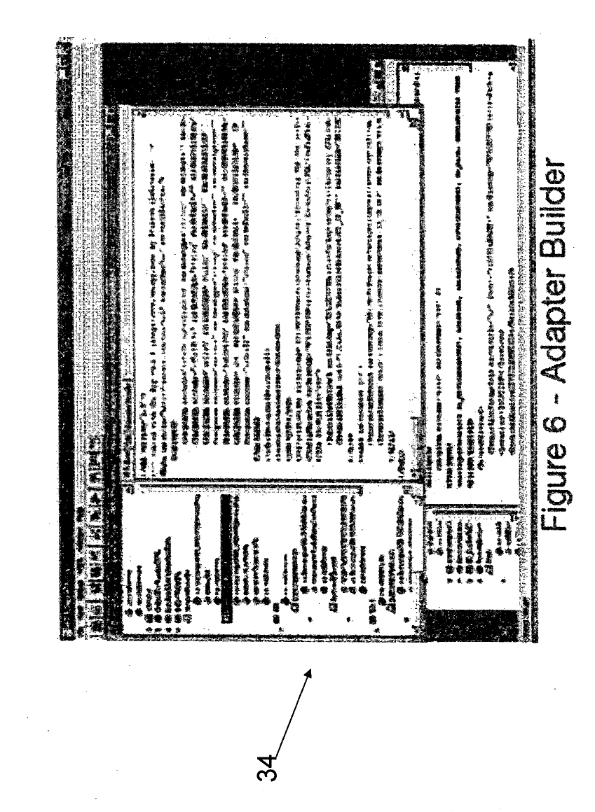

In one embodiment, the design application 20 allows a user to access a particular source file and launch the builder application associated with that file. The data model builder 32 is a software application that may be launched when the user selects one or more of the XML source files associated with the file. The builder 32 models a data structure and constraints using, for example, the Unified Modeling Language (UML). The data model 72 created is a complete abstract model of all the data needed to deploy the service. In one embodiment, the data model builder 32 provides a graphical interface and tools to create and edit UML class diagrams called data models. The data model builder interface consists of a main window divided into three panes: Navigation pane, Editing pane and Details pane. FIG. 5 depicts an example of such an interface. As shown the data model builder 32 has menus, context menus and toolbar icons. The data model created by the data model builder 32 is typically an XML schema (XSD) or a schematron extension to the XML schema. The data model instance describes the valid data structure for a service in the service package 22.

The depicted adapter builder 34 allows for non programmatic creation, editing and configuration of adapters 52 to the external systems 30. The adapter builder 34 allows data and function mapping through a graphical user interface. The developed adapters are XML translation files that can get data in and out of the external systems so that the runtime process 12 can communicate with the external networks 30 for the purposes of deploying the ordered service. Therefore, the adapter builder 34 is typically as XML source file generator for creating translation files that translate data exchanges between two different sources.

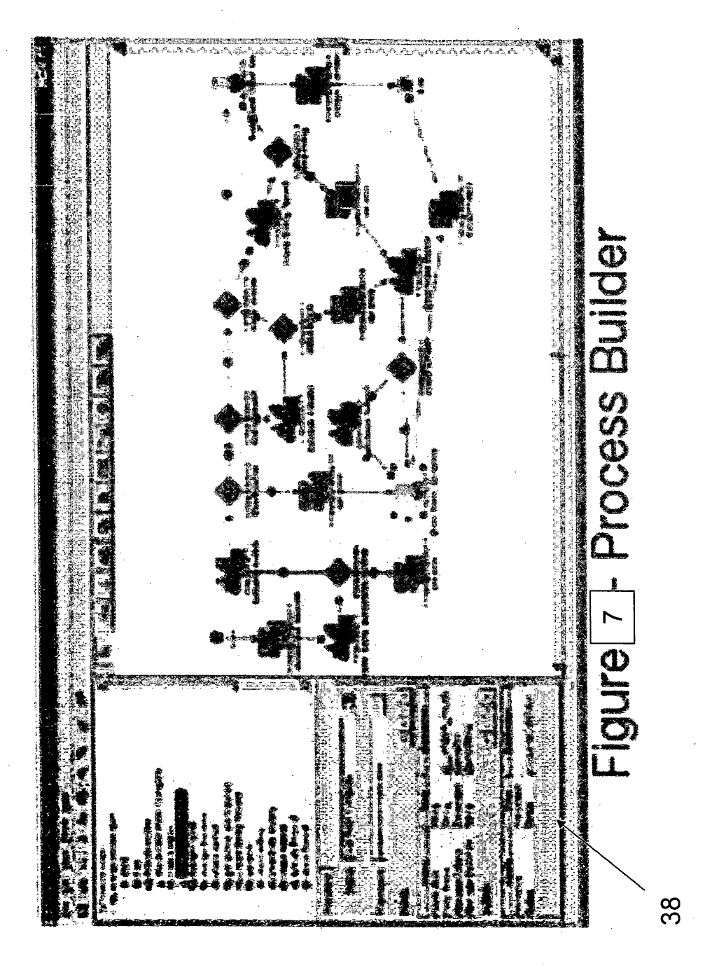

The depicted process builder 38 is employed to create workflow process models 62 that are processed by the workflow engine 40. Process models 62 may contain activities, sub-processes and dynamic models to be constructed at runtime. FIG. 7 illustrates the process builder 38 allows the user to create a graphical model of the process that takes place on the external system 30 when deploying the service.

The system 10 allows customers to create service packages 22 specific to their needs. Optionally, the system 10 may come with specific service packages 22. IP-VPN is an example of a service package 22 product. Because a service offering is specific to a particular customer's needs and environment, a service package product can be understood as a prototypical instance of the service(s). A productized service package 22 will simulate the typical customer environment by providing template implementations of back-end systems such as inventory and billing systems. The customer will customize the service package 22 to fit his/her needs and environment.

The IDE 14 is, in one embodiment, a JAVA GUI application used to create, view and modify service packages 22 (and modules). The creation of a service package 22 is much like the creation of any software. It is designed, implemented, and tested. Testing involves deploying the service package 22 to the runtime module 12 and sending an order request. This is typically an iterative process. During testing and in production the service package 22 is analyzed while it is processing orders to make sure it meets its functional and performance requirements. This analysis can identify changes to be made. The process can be repeated to create a new version of the service package 22. Finally the old version can be retired (removed). The IDE 14 allows storing service packages 22 in a source control system.

The IDE uses the project metaphor. A service package or module is a collection of related files on disk that are grouped together and referenced by a project file. The project file along with all the files it references is the specification of the service package.

The IDE can be installed and used independently from the runtime module 12. A connection to the Runtime 12 is only needed for deploying, and testing modules. The IDE can also query the Runtime 12 to get a list of modules and their entry point descriptions and a list of external system descriptions. The IDE can also add and edit external system descriptions using the console 18.

Service Packages

In one embodiment, the service package 22 is a set of data files that contain instructions for directing the runtime module 12 to carry out a service, such as installing cable modem Internet service for a customer. The service package 22 is preferably a ready to deploy, self contained software overlay which encapsulates the request handling, business logic, workflow rules and interface connectivity to deploy a service.

The service package 22 is a complete definition of a service or set of related services, allowing for rapid service creation by encapsulating all of the definitions, configurations, parameters, and actions that comprise a communications service.

The three major components that comprise a fully defined service in the service package 22 include:

Data Models 72 that, in one embodiment, define the schema of XML data used within the service. Data Models 72 define data received from and sent to external systems 30 in a way that is abstract from a concrete external system. They define a generic data structure that can represent data received from or send to any external system of the same kind. Having such a generic data representation allows service package 22 components to perform the same procedures on that data during service fulfillment process regardless of a particular kind of external system actually supplying this data. Service order request is an example of such data: the service order definition represented by the Service Order Data Model contains definition of all service features and parameters and all the other parameters that can come in the service order request, that are important and are used in the service fulfillment process. This Service Order Data Model should be independent from a particular format of the service order request coming from a particular Order Entry system.

One example of a Service Order Data Model is set out below in Table 1

TABLE 1
Example of an XML file passed to the runtime AP engine

The XML representation of the
Service Order Data model template looks like this:
Create the Service Package
<?xml version=“1.0” encoding=“UTF-8”?>
<APRequest xmlns:xs=“http://www.w3.org/2001/XMLSchema”>
<orderdate>string-value</orderdate>
<orderrefid>string-value</orderrefid>
<subscriberinfo>
<subscriberid>string-value</subscriberid>
<subscribername>string-vaiue</subscribername>
</subscriberinfo>
<billingInfo>
<streetaddress>string-value</streetaddress>
<state>string-value</state>
<city>string-value</city>
<zipcode>string-value</zipcode>
</billingInfo>
<paymentinfo>
<paymenttype>string-value</paymenttype>
<creditcardno>string-value</creditcardno>
<creditcardexpirydate>string-value</creditcardexpirydate>
</paymentinfo>
<ServicePackageName>
<ServiceName/>
</ServicePackageName>
</APRequest>

The example Service Order Data Model contains definition of all service features and parameters and all the other parameters that can come in the service order request, that are important and are used in the service fulfillment process. These example parameters include information about the order, such as the date the order originated (orderdate) and information about the customer, such as subscriber name. Additionally, billing information may be defined as well, as can any other information that an external system 30, such as a billing system or a softswitch, may require.

The data model 72 provides a platform on which other parts of the system can build. For example, the data model 72 may be used by the process builder 38 to construct path expressions that allow access to data within XML instances described by that data model 72. Additionally and optionally, the data model 72 may produce an XML Schema and Schematron extension that are used at run time to do extensive validation of an XML instance documents. This validation may include enforcement of the structural constraints as well as constraints on values and relationships between values and attributes. Adapters 52 communicate with external systems 30 to retrieve and send data. Adapters 52 map received data from a device specific format into an XML instance of a corresponding data model 72, and send data from an XML instance of a corresponding data model 72 in a format specific to the particular external device.

In one typical embodiment, communication with any and all external systems 30 is the responsibility of the adapter 52. Adapters 52 describe how to get information into and out of external systems 30. Adapters 52 provide a way to handle communication with external systems 30. The adapters 52, in one preferred embodiment, produce an XML view of interaction with one or more external systems 30. An XML view is a logical grouping of data organized in an XML document. Each adapter 52 may produce its own specific XML view according to the data model 52 that describes data coming from or going to that external system 30. XML views allow all the systems in a service provider's environment to be seen as a single virtual super information server from the point of view of the service package 22. An adapter 52 may support bi-directional communication. The adapter 5 can retrieve data from external systems 30 and store data in external systems 30. A single adapter 52 can be created aggregating data from several external systems 30 to produce an XML view of a data model 72 that has the data needed for the service, or to decompose data from an XML instance of a data model 72 such that it is stored in multiple external systems 30, or to do both. The adapters 72 support communication with both synchronous external systems that return result right away, and asynchronous external systems that treat the request as an order to carry out some processing. Once completed, they send a completion notification with the results.

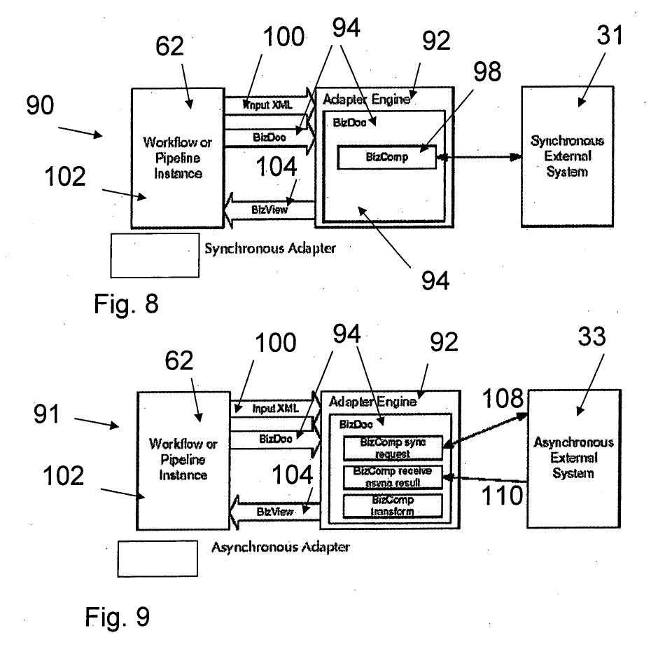

Thus, the adapter 52 connects the system 10 and an external system 30 and then presents a single XML view of data from a single or multiple sources. One embodiment of an adapter 52 is shown in FIG. 8. Specifically, FIG. 8 depicts a block level diagram showing the structure of one embodiment of a synchronous adapter. During a synchronous interaction, the data is exchanged (either inbound or outbound) with a single call (request and response) or a single message to an external system. More particularly, FIG. 8 depicts a synchronous adapter 90 that includes several inter-operating components including an adapter engine 92 that receives from the workflow instance 62 a stream of input XML 100, a well formed XML file 94 that specifies a document format. A processing component 98 can perform dynamic data generation and can retrieve static data and insert new data or data that has been updated into the document format, and to this end the processing component 98 can exchange information with the synchronous external system 31.

Accordingly, FIG. 8 depicts that the adapter engine 92 receives a stream of XML 100. The stream of XML 100 can be the data that is collected from different data sources including for instance the order handling system that has information about the order placed by a customer, and information retrieved from an inventory list showing the inventory of provisions and resources available to service the requested order. Either way, a stream of input XML 100 can be delivered to the adapter engine 92 as well as the well formed XML file 94. The adapter engine 92 can be an XML processor that processes the input XML and the well formed XML file 94 to activate the processing component 98 and cause that processing component 98 to collect information from one or more synchronous external systems 31. The information and data collected by the processing component 98 may be ordered into a single XML view of that data and returned through the XML stream 104.

In one particular embodiment, the adapter 90 is constructed using the Biz View system from the Xaware company of Oakland, Calif. The Biz View architecture supports data integration tasks and provides a set of metafiles including Biz documents, Biz components, and Biz drivers. The Biz document contains a hierarchical set of XML view of the service data. The Biz document initiates Biz components that it references. The Biz components are processing components, such as the depicted processing component 98. The Biz component may retrieve data, insert new data or insert new data that has been updated by a client. The Biz component can also return any data it receives from a data source, such as the external source 31, to the requesting well formed XML file, the Biz document 94. At the physical layer, a set of drivers, Biz drivers, enable a Biz component to connect to any standard or customized external system 30. In this way, the protocol of the external system 30 can be matched by the adapter for the purpose of transmitting data at the physical layer between the adapter and the external system 31.

Thus adapters may be stored as XML files. This XML view is referred to as a BizView. A single, adapter generally requires construction of at least three files:

A BizDocument (BizDoc) In this embodiment, this is the main document and it provides the starting structure for the resulting BizView into which the results of processing BizComponents are inserted. It contains references to BizComps.

One or more BizComponents (BizComps) .XBC. This is a component and represents the data in a sub tree of the resulting BizView. A BizComp may refer to a BizDriver.

A BizDriver .XDR. to accompany the BizComponent(s) This is a driver used by components to describe connection information for external systems.

The logical layering of processing within the adapter builder 34 separates the document format 94 (BizDoc) from the dynamic data generation 98 (BizComps) and the physical data access layer (BizDrivers). This layering has the benefit of isolating components to make them reusable. The physical layer isolates the complexities of data connectivity to a distinct data access layer. The document format 94 is a well-formed XML file that consists of one or more XML elements. Each element may have an associated element type as well as optional text values, attributes and child elements. The elements in the document format 94 can operate from any number of data sources.

FIG. 9 depicts an asynchronous adapter 52. An asynchronous interaction is initiated with a call or message to an external system 30 that constitutes a request. In the case of a call, the external system 30 will reply with an indication that it has received and accepted the request but this is not the final result. The external system 30 works on the request and when it is complete the result is sent back to the adapter 52 as a message or a call back. This is accomplished by using asynchronous processing components 98 within the document format 94. As with synchronous interactions, data in asynchronous interactions can flow in either direction, inbound or outbound.

More particularly, the asynchronous adapter 52 depicted in FIG. 9 includes an asynchronous adapter 91 that includes several inter-operating components including an adapter engine 92 that receives from the workflow instance 62 a stream of input XML 100, a well formed XML file 94 that specifies a document format. A processing component 98 performs dynamic data generation and retrieves static data and inserts new data or data that has been updated into the document format, and to this end the processing component 98 can exchange information with the synchronous external system 31. As discussed above, an asynchronous interaction is initiated with a request 108 to the external system 30. The external system 30 will reply with an indication that it has received and accepted the request 108 but this is not the final result. The external system 30 works on the request 108 and when it is complete the result 110 is sent back to the adapter 52 as a call back. As shown, this may be accomplished by using two asynchronous processing components 98 within the document format 94. One processing component 98 sends the request 108 and the other processing component 98 receives the result 110.

Adapters 52 may be created using the adapter builder 34, using data models 72 as examples of the desired XML view and wizards and templates for describing data mapping from the external system 30 to the XML view, connection information, processing logic and data aggregation and decomposition rules. Adapters 52 produced by the adapter builder consist of a set of XML documents that work as templates that drive the adapter engine 92.

In some alternate embodiments, the adapter 52 is more limited in scope and only provides access to a single system or type of system for a particular programming language/environment. For example, JDBC provides access to SQL database systems for Java Language programs. In some other embodiments an adapter 52 is a remote procedure call wrapper around a native API to a specific system for a particular programming language.

Process Definitions 62 are the third component of the service package 22 and describe the overall procedural processing to be done for service fulfillment. They implement the business rules that govern the service and orchestrate the fulfillment of services. As used herein, the term business logic shall encompass, although not be limited to, the business process information of an organization that comprises the evaluations, decisions, transitions, transformations, requests and responses needed to carry out its service deployment, or other business function. This can include customer account data, parameters for operating devices, such as soft switches, information that needs to be obtained, such as inventory availability information, and any other information that is required to deploy the service. The function of the service package 22 is to capture this information to allow it to be enacted in an automated process and monitored and updated as necessary. When an order request is received it is the name of the service package 22, service and action contained in the request that determine which process definition 62 is invoked. The process definition 62 determines the overall procedure for fulfilling a request to perform an action on a service.

To this end, the process definition 62 provides information about the order in which activities occur.

Process Definitions 62 are made up of the following elements common for most of workflow systems:

Activities: Activities are units of work to be done and can be subdivided into three categories, which include activities executed by processors. The set of processors are described later but they include such things as validating XML documents, executing adapters, performing XSL transformations, and other similar functions.

Decisions: Provide conditional branching; and

Transitions: a flow of control between activities or other nodes.

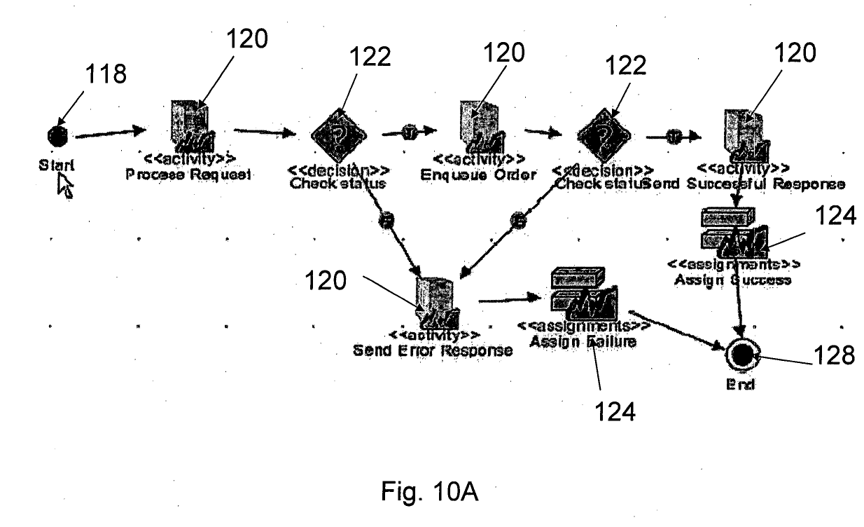

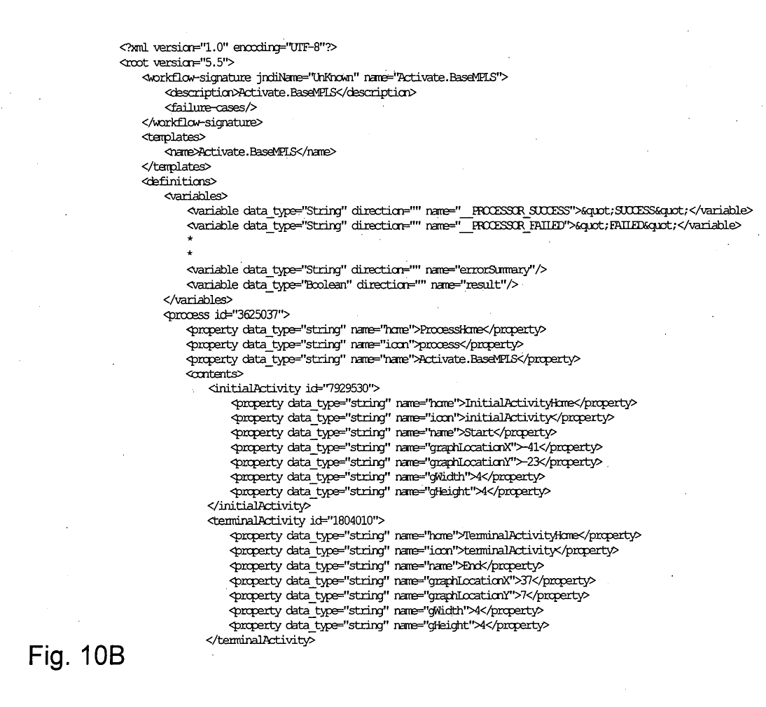

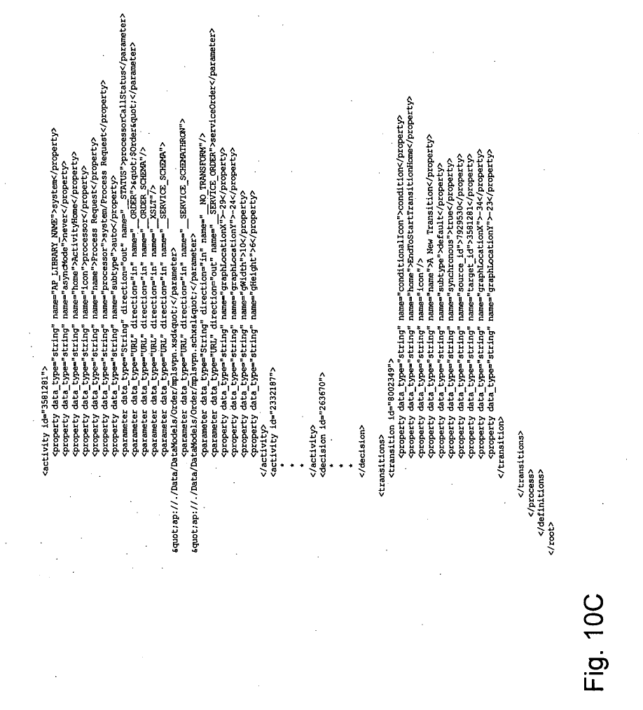

FIG. 10a depicts graphically the process definition for the order handling work flow template. This template is a generic top level business process definition designed to validate the requests and then move the request to a cue for processing. As shown, FIG. 10a graphically depicts the process as a data flow diagram that begins at a start point 118 and moves through a series of specific activities 120 and decision points 122. For the particular order handling process definition depicted in FIG. 10a there are two assignment operations 124 that occur for the process definition is terminated at termination point 128. The depicted order handling process definition includes a series of activities that are used to validate and queue an incoming order. As shown in FIG. 10a each activity 120 has a particular title, such as process request. This activity may be associated with a set of instructions or a process that can be used by the system 10 for implementing that activity.

To this end, the process definition builder 38 may process the graphical depiction of the order handling work flow to develop a set of XML source files that include XML statements and definitions that correspond with the different activities and decision points portrayed in the process definition shown in FIG. 10a. Turning FIG. 10b and FIG. 10c one edited example of such an XML source file is presented. As shown therein, the source file includes a set of activity blocks including blocks associated with the initial activity of starting the process as well as terminal activities for ending the process. The source file also includes a set of statements that define processes that can be associated with different activities and decisions as well as assignments that are present within the graphical representation of the process definition. To carry out the necessary actions, the activities can be associated with different processors. These processors may be invoked by the work flow engine 40 shown in FIG. 1.

A processor is the code to implement a specific function. It is the equivalent of a function or procedure in other languages such as C. It has a declaration (or signature) that describes the inputs and outputs and an implementation, which is the code that does the actual processing. Processors are invoked by the workflow engine 132 from workflow activities. The processor can be thought of as the type of workflow activity or process. Examples of processors include an adapter invoker process. For example, a process definition activity may call the “Update billing information” processor that starts the adapter capable of exchanging data with the appropriate billing system or systems. Processors can be created using any suitable technique, including, but not being limited to using EJBs and simple Java classes.

A processor takes as input zero or more XML documents, zero or more parameters that are name value pairs and produces zero or more XML documents as outputs, zero or more parameter name value pairs and also returns a status of success or failure. Processors do the work in a process/activity. A process names a specific processing step and connects specific inputs and outputs to a processor. At runtime the process definition becomes a process instance when it is invoked. The process instance calls the processor implementation with specific values for the inputs and on return the outputs are stored. From the point of view of the caller of the processor, the processing is synchronous. If a processor can be blocked for an arbitrarily long time then internally the implementation must be asynchronous so as not to block a thread for a long time. But from the users view of the workflow or pipeline it looks as if it is synchronous.

As discussed above, the service package 22 may be understood to include a data model 72, a process definition 62 and one or more adapters 52. The data model 72 provides an abstract data model of the data needed to deploy the service. The service package 22 encodes this abstract data model and the business logic into a set of data files that can be interpreted by the runtime module 12. In one embodiment, the data files are XML source files created by employing a process logic design tool for defining process logic as process models that may be enacted by a runtime environment, such as the runtime module 12. One such system is the Versata Logic Studio, manufactured and sold by the Versata Company of Oakland, Calif.

Runtime

The runtime module 12 is a system for processing requests and interacting with external systems 30. The runtime module 12 interprets the service package 22 to carry out the process described by that service package 22 for the fulfillment of orders. It contains a workflow engine 40 to carry out the process. It contains an adapter engine 44 for interacting with external systems 30. The internal representation of data related to a service package 22 is typically XML. In this way runtime module 12 can be seen as a general purpose XML processing system but it is applied to the specific task of processing orders. The information the runtime 12 needs to keep including data about service packages 22 and orders is stored in a database 24, shown in FIG. 1. The runtime module 12, in one embodiment, is implemented as a collection of servlets, EJBs and JAVA code packaged and deployed as an Enterprise archive in a J2EE server or cluster.

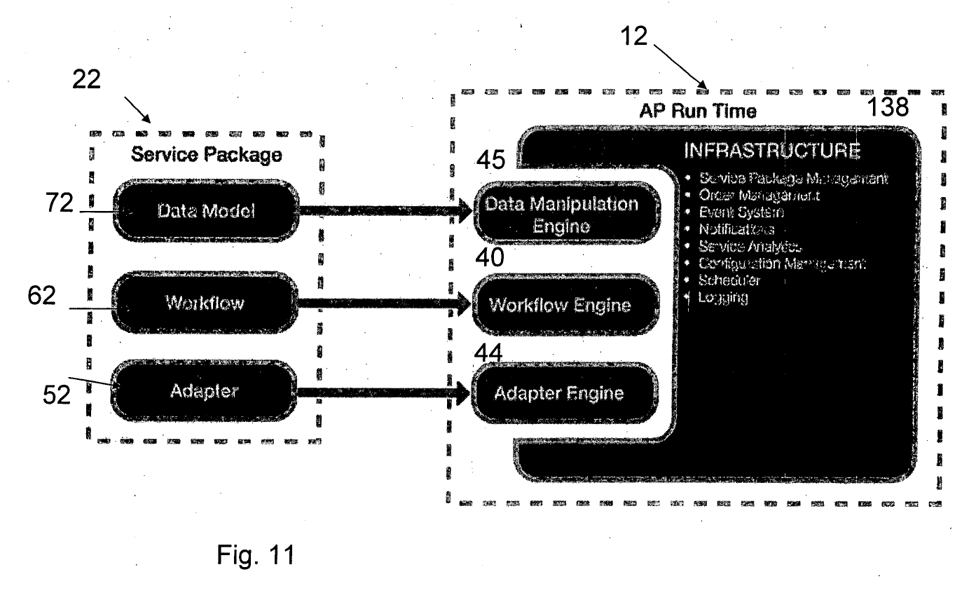

Turning to FIG. 11, the interaction between the service package 22 and the run time module 12 is depicted. Specifically in the embodiment shown in FIG. 11 the run time environment includes a work engine 40 and adapter engine 44, a data manipulation engine 45 and a set of infrastructure code 138.

The adapter engine 44 received the adapter 52 and responsive to the information stored within the adapter 52 activates the necessary programming logic to carry out the processes defined by the adapter 52. In one embodiment, the adapter engine is an XML translation engine capable of translating XML statements within the adapter 52 to activate the necessary programming logic to carry out actions defined within the adapter 52 and to format data as required by the adapter. The development of such XML processing engines is known to those skilled in the art and any suitable type of engine may be employed with the systems and methods described herein.

FIG. 11 further shows the work flow engine 40. The work flow engine 40 receives the work flow or process definition 62 from the service package 22. As described above the work flow engine 40 may also, in one embodiment, be a XML translation engine capable of translating the XML source file associated with the process definition 62 into a set of data documents and program logic that carries out the actions defined by the process definition 62. The development of such work flow engines follows from principals well known in the art and any suitable work flow engine may be employed without departing from the scope of the invention.

The run time module 12 also includes a data manipulation engine 45. The depicted data manipulation engine 45 receives the data model 72 from the service package 22 and operates on the data model. To this end the data manipulation engine 45 can extract necessary information from the data model to provide the work flow engine and the adapter engine with the data that is required to carry out the service or services defined by the service package 22. In one embodiment the data manipulation engine is a software program capable of sorting through the data model 72 in response to requests from the adapter engine and the work flow engine to supply portions of data stored within the data model 72. The development of such software programs is known to those with skill in the art and any suitable suitable software capable of extracting and organizing information stored in a data model may be employed with the systems and methods described herein.

Returning to FIG. 1, the depicted console 18 may be a web based UI for configuring and managing the Runtime module 12. The Console 18 allows one to list and manage service packages 22 that are deployed to the runtime model 12. It may also list and manage orders in the system. The order entry system 20 is an external system that is responsible for taking the order request and handing it to runtime module 12 for processing. The external systems 30 represent any number of the wide variety of external systems that the system 10 can interact with via adapters. These external systems 30 could be OSS, BSS, NEs databases etc. As will be described in more detail below, the service analytics module 16 is a GUI application used to view statistical reports on order processing. It is used to measure the performance of a specific service package(s) or order processing in general. As the runtime module 12 orders it records what happens to the order in a database 28. This data is used to drive the service analytics reports.

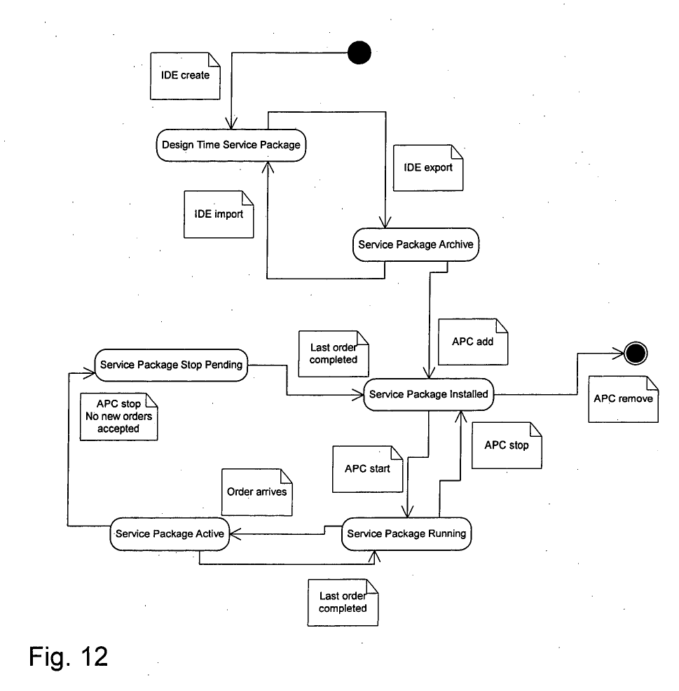

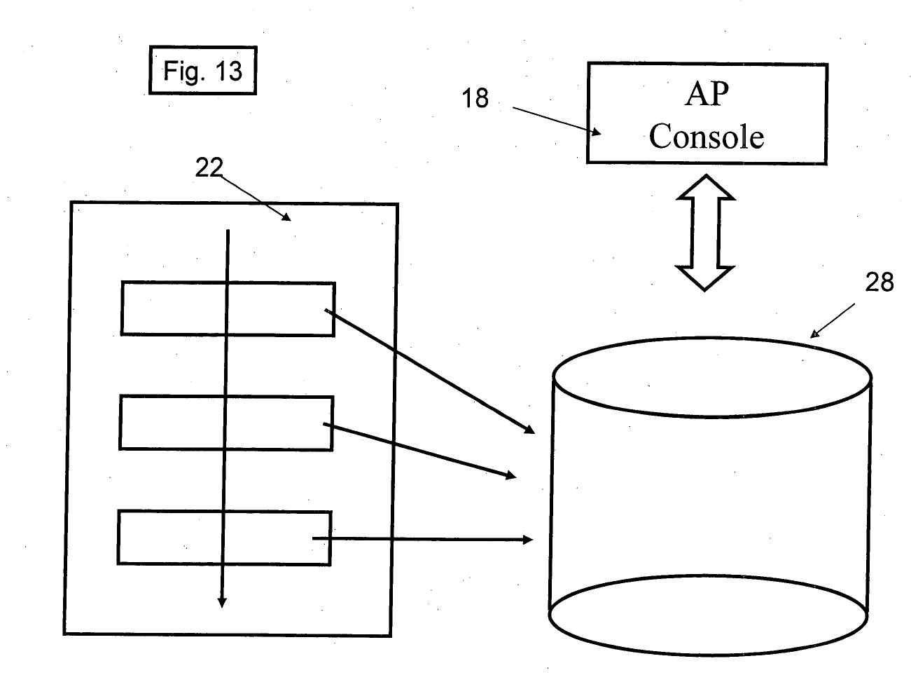

FIG. 12 depicts the operation of the system 10 as it creates and invokes a service package 22. A Service package 22 starts when it is created by the IDE. This is the design time state where it is edited, and modified over time.

From the IDE 14 the service package 22 moves to the platform supporting the run time module 12. The platform or console 18 adds the service package 22 to the Runtime module, typically via a API. This puts it in the installed state. In the installed state the data in the service package 22 archive that is needed by the runtime 12 is moved into a runtime data store. The platform can start and stop a service package 22 to move it to/from the running state. It is in the running state that a service package 22 can actually fulfill orders.

When an order comes in, the runtime module 12 changes the appropriate service package state from running to active meaning that one or more orders related to that service package 22 are currently being worked on. When there are no more orders in the system related to this service package 22 then it is moved to the running state where it again can receive more orders. Typically, while the service package 22 is active it cannot be stopped because that would affect orders. So in response to a request from the console 18 to stop the service package 22 the runtime module 12 moves the service package 22 to the stop pending state where it will continue to work on orders already in the system but will not take any new orders. Once all the orders are complete the service package 22 transitions to the installed state. When a service package 22 is stopped (in installed state) any orders received for services in that service package 22 are failed.

The console 18 can remove a service package if it is in the installed state. So the remove action should be disabled in the UI if the service package is running. Removing the service package 22 marks the end of life for the service package.

Service Analytics

In certain embodiments, the system 10 includes the service analytics process 16. In one embodiment the service analytics process 16 is a standalone GUI application that provides visualization, reporting, and measurement of services being deployed on the external systems 30 by the service packages 22 executing on the system 10.

To this end, the runtime module 12 may record relevant data about the processing done in fulfilling or deploying orders for services. This data is stored in the database 28. The service analytics process 16 may be a software application that reads and processes this data to create a variety of reports. The service analytics process 16 does not need to be executing on the same machine or the same time as the runtime module 12. It just needs to have access to the database 28.

A number of different report formats may be provided, and optionally, the user may develop their own report. The primary unit of measure is typically time. Most of the information in the reports is about how long did it take to process a step in the service, or how many orders were processed during a particular time. There are also counts of things such as how many orders.

To collect information about the service deployment process, in one practice a high level structure of the order fulfillment/service deployment model is created. As discussed above, the service deployment process comprises a series of sequenced processes, as shown graphically in FIG. 10A. As also shown, each process has a name. There are multiple levels of processes. At the lowest level there are the processes implemented by a single processor. This could be invoking an adapter to a particular external system such as inventory control system or performing an XSL transform on some data. These elementary processes are sequenced by process definitions. Processes can be invoked from other processes. At the highest level there is the process of fulfilling the order.

What emerges as an order is processed is a tree of processes. For example the following Table 2 shows a partial tree of processes that might result from processing an order that activates the IPVPN service package. Indentation is used to show parent child relationships. Each line represents a node in the tree, which is the name of a process. The text after the // is an annotation for purposes of describing the example.

```
TABLE 2
Activate IPVPN // top level pipeline, the entry point for
processing the order
  Validate order // first process, which is done by the Request processor
    Accept order // workflow started from Request processor
      Send response // this accepts the order request
      Handle order // use Enqueue processor
        Handle interdependencies // workflow
          Provision Routers // pipeline
            Get inventory // Adapter gets inventory
            ...
            Configure router // Adapter updates
router 1
            Configure router // Adapter updates
router 2
          Update billing // workflow to update billing
            ...
          Configure bandwidth // pipeline
            ...
          Send completion // uses notification processor
```

This view of the process allows the service analytics process 16 to view whether different sub-processes were successfully completed. The problem is that it needs to be aggregated in a meaningful way to produce the reports needed. The benefit is that this view is very useful for order tracking and determining where an order is should it get “stuck”.

An optional practice is to instrument the service package 22 to specify and label the points between which you want to measure. Optionally, this can be done by the package developer 20 or automatically included within certain processes.

FIG. 13 depicts one embodiment of a system with a service package 22 that has been instrumented to include points for gathering information about the success of processing an order, including the time in which an order can be processed. As shown in FIG. 13, the service package 22 executes through various points within the service package 22 that detect the processing that has occurred up to a certain point. At that point, information can be generated which can be delivered to the analytics database 28 and stored therein. As described above the information that can be collected at these breakpoints can include the rate at which orders are processed, the rate at which events within the order are processed such as the provisioning of resources, ordering of equipment, such as a cable modem, and other such performance information. This information can be stored on the analytics database for subsequent viewing by the user. Techniques for instrumenting the service package 22 can follow from known techniques including techniques employed to debug executing programs, including those discussed in U.S. Pat. No. 5,987,249 Grossman, et al, the teachings of which are incorporated by reference. Other techniques for collecting information from a service package 22, a process definition or any other executable process may be employed herein without departing from the scope of the invention.

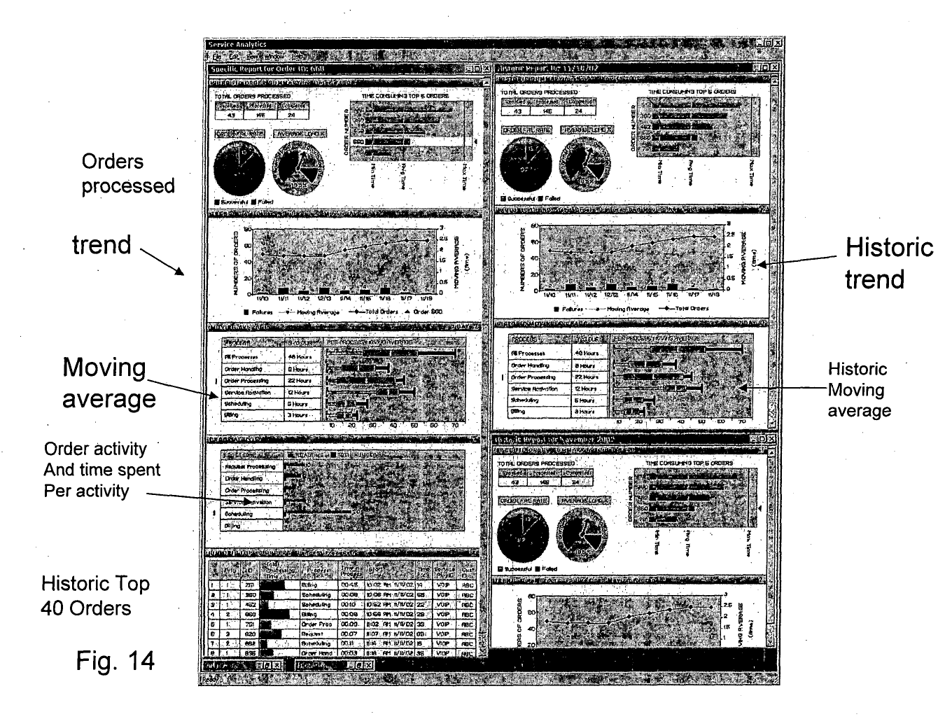

As shown in FIG. 14, the analytics database 28 can store current and historical performance data. Specifically, FIG. 14 depicts one embodiment of the system wherein the console 18 includes a dashboard user interface presented on the console 18. Within the dashboard interface can be information that shows a comparison between an old and a new version of a particular service package 22. For example, a service package 22 can be updated and saved as a new version. The platform can execute the revised service package 22 and analytical data can be collected from that package 22 through instrumentation within the service package code. The data collected from this new version may be stored in the analytical database 28 and compared to data collected for an earlier version of the same service package 22. In this way, the user can compare different versions of a service package 22 to determine which version provides the best results. Moreover, the user can employ the instrumentation within the service package 22 to identify trouble spots within the service package, a business process or some other aspect of the order fulfillment process. In this way, a user can debug the manner which an order is fulfilled, as well as make determinations as to the efficacy and benefit of a newly deployed version of a service package 22.

To support service analytics the runtime module 12 generates the data that service analytics process 16 needs. It does this by firing events in response to specific things that happen in the runtime module 12. Examples of events are:

Order started

Order completed

Process started

Process ended

Order related events contain most of the information about the order from the order table including the state and status, and the time (start or end) of the order event. Process related events include the order the process is related to, the parent process (the one that called this process), the process name, the module the process belongs to, processor/processor type, external system if applicable, status, and the time (start or end) of the event. Together the persisted data in these order and process events constitute the historical record of the order. This historical record is separate from the runtime data. The events are generated and persisted as they happen. So the service analytics 16 real time reports are based on the same historical record as the historical reports. The difference is that the orders in the real time reports have not yet completed. Optionally, the console 18 is used to configure the database 28 that the historical record is persisted in (by configuring event handlers).

One advantage of automated or semi-automated order fulfillment is that is allows for automatic order fulfillment. For example, in one application of the present system when a wireless subscriber enters a new service area, it may be that the systems of the invention are employed to automatically subscribe the user to a new service. For example a wireless subscriber that enters an area serviced by a wireless provider employing the system subscribed area, may automatically be subscribed to certain wireless services, such as wireless map quest, tourist information, flight information, or other kind of information that the user may employ while within that wireless providers area. As can be seen from the above description, the systems and methods of the invention allow for automatic enrollment of the wireless subscriber as soon as their handset is recognized by the new service provider. Once recognized, the provider can send a message to the user indicating that the user, at their option may subscribe to certain services that the user may find helpful. In certain practices, the services may be provided for free, while in other practices the user may pay for some or all of the services to which the user subscribes.

The design and development of the order fulfillment systems described herein follow from principles known in the art of computer programming, including those set forth in Wall et al., Programming Perl, O'Reilly & Associates (1996); and Johnson et al, Linux Application Development, Addison-Wesley (1998).

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

We claim:

1. A method for deploying improved telecommunications services, comprising providing one or more existing service packages, each being a set of instructions for deploying a telecommunications service,
providing a platform run time environment having a workflow engine and a pipeline engine and being capable of interpreting the service package to carry out the instructions therein,
providing a user interface for configuring the one or more service packages, the user interface configured to receive user input by offering a plurality of functional elements that may be manipulated by a user to describe one or more operations of the service packages, each functional element having one or more properties that may be controlled by the user, and configuring one or more features of the service packages in response to the user input to alter the telecommunications service.

2. The method of claim 1, wherein the user input includes at least one of data dependencies, service states, or an external OSS application.

3. The method of claim 1, wherein the user input includes a service dependency definition.

4. The method of claim 1, wherein the user interface includes a service creation environment.

5. The method of claim 1, wherein the user interface includes a graphical user interface for processing the instructions in a service package to visually depict a process for deploying a telecommunication service.

6. The method of claim 1, including a graphical user interface for visually creating an adapter that provides a functional interface to an external system that provisions a telecommunications service.

7. The method of claim 6, further comprising creating a plurality of adapters.

8. The method of claim 6, wherein the functional interface includes enabling and disabling connectivity.

9. The method of claim 6, further comprising managing connectivity of the adapter through the user interface.

10. The method of claim 1, further comprising storing as a service package a configuration that results from configuring one or more features of the programmable telecommunications resources.

11. The method of claim 1, further comprising providing a library of service packages.

12. The method of claim 1, further comprising providing a second user interface for managing the library of service packages.

13. The method of claim 1, wherein the telecommunications service includes at least one of VOIP service, a next generation IP based secure VOIP service, VPN service, a wireless service, and a carrier message service.

14. The method of claim 1, wherein the telecommunications service is a carrier managed service.

15. The method of claim 1, wherein the user input is received through a data network from an end user of telecommunications services.

16. A method for monitoring telecommunications services comprising:
providing a software configurable telecommunications resource;
configuring one or more features of the resource in a configuration to provide a telecommunications service; and
monitoring at least one objective characteristic of the service.

17. A method according to claim 16, further comprising storing time dependent data reflecting the objective characteristic.

18. A method according to claim 16, further comprising analyzing the objective characteristic to evaluate the configuration.

19. A method according to claim 16, wherein the at least one objective characteristic includes a cost of the telecommunications service.

20. A method according to claim 16, wherein the at least one objective characteristic includes a statistic related to the telecommunications service.

21. A method according to claim 16, wherein the at least one objective characteristic is measured at a user-specified location within a telecommunications system.

22. A method according to claim 16, wherein the at least one objective characteristic is measured at a user-specified location within a software process.

23. A method according to claim 16, the software process comprises at least two stages, one of the at least one objective characteristics being measured within one of the at least two stages.

24. A method according to claim 16, wherein an effectiveness of the configuration is determined specifically for a stage.

25. A method according to claim 16, wherein configuring one or more features of the service includes automatically provisioning one or more telecommunications resources.

26. A method according to claim 16, wherein configuring one or more features is performed over a data network.

27. A method according to claim 16, further comprising determining whether the configuration was successfully implemented on the software configurable telecommunications resource.

28. A method according to claim 16, further comprising determining whether the telecommunications service was successfully provided to a customer;

29. A method according to claim 16, further comprising displaying the at least one objective characteristic to a user in at least one of a graphical form or a numerical form.

30. A method according to claim 29, further comprising displaying the at least one objective characteristic over time.

31. A method according to claim 29, further comprising displaying a current value for the at least one objective characteristic.

32. A method according to claim 29, further comprising displaying a diagnostic indication for at least one location within a telecommunications system or a software process.

33. A method according to claim 29, further comprising identifying one or more problems within a software process relating to the software configurable telecommunications resource.

34. A method according to claim 29, further comprising providing a recommendation to a user for a revision to the configuration.

35. A method according to claim 29, wherein the recommendation provides an incrementally optimal improvement in the objective characteristic relative to an increase in a cost of the revision.

36. A method according to claim 29, further comprising changing the configuration to provide a second configuration and comparing the objective characteristic under the configuration to the objective characteristic under the second configuration.
